(19) United States
(12) Patent Application Publication
(10) Pub. No.: US 2023/0162410 A1
(43) Pub. Date: May 25, 2023

(54) Multi-spectral Auto-fluorescence based Stainless and Slide-free Virtual histology

(71) Applicant: CytoVeris Inc., Farmington, CT (US)

(72) Inventors: Rishikesh Pandey, Unionville, CT (US); Guoan Zheng, Vernon, CT (US); Alan Kersey, South Glastonbury, CT (US)

(21) Appl. No.: 17/992,613

(22) Filed: Nov. 22, 2022

Related U.S. Application Data
(60) Provisional application No. 63/281,939, filed on Nov. 22, 2021.

(51) Int. Cl. G06T 11/00; G06T 7/30; G06T 3/40; G01N 21/64

(52) U.S. Cl. CPC G06T 11/001; G01N 21/6486; G06T 3/40; G06T 7/30; G06T 2207/10064; G06T 2207/10152; G06T 2207/20016; G06T 2207/30024; G06T 2210/41

(57) ABSTRACT

A system for and method of producing a virtually stained histological tissue sample is provided that includes: a) acquiring a plurality of autofluorescence (AF) images of an unstained tissue sample, each AF image of the plurality of images produced by interrogating the tissue sample at an AF excitation wavelength configured to produce AF emissions at an AF emission wavelength, wherein the AF excitation wavelength and the AF emission wavelength used to produce each AF image of the plurality of AF images is different from the AF excitation wavelength and the AF emission wavelength used to produce the other AF images of the plurality of AF images; b) virtually staining the tissue sample using the plurality of AF images using artificial intelligence to represent a coloration of at least one histological stain; and c) producing a virtually stained histological tissue sample from the virtual staining.

This application claims priority to U.S. Pat. Appln. No. 63/281,939 filed Nov. 22, 2021, which is hereby incorporated by reference in its entirety.

### BACKGROUND OF THE INVENTION

### 1. Technical Area

The present disclosure relates to systems and methods relating to tissue samples in general, and to systems and methods for analyzing tissue samples that utilize digital images in particular.

### 2. Background Information

Histopathological investigations that rely on morphological features of tissues remain the gold standard for the diagnosis, staging, prognosis, and treatment of cancers. This century-old clinical practice requires time-consuming fixation, embedding, microtoming, and the like. The formalin-fixed, paraffin-embedded (FFPE) tissue slices are stained with various histological stains such as hematoxylin and eosin (H&E) to provide necessary contrast for visual inspection of tissue architectures. The slides are examined by a pathologist under a microscope, and the pathologist’s interpretations of the tissue result in the pathology “read” of the sample; e.g., see FIG. 1. However, there are several shortcomings associated with this clinical practice. First, the process is labor-intensive and time-consuming, and the results are known only after days and sometimes weeks. Second, the stain coloration from a single histological stain may not itself enable differentiation of applicable tissues, cellular structures, or chemical substances. Historically, this dilemma was resolved by preparing multiple tissue sections, each stained with a different histological stain. The multiple prepared tissue sample sections were collectively relied upon to provide the requisite information for the “read”. Third, the evaluation or “read” of tissue sample sections is subjective and depends upon the experience and expertise of the pathologist. Fourth, a tissue section cannot be reused for any other analysis, and one tissue section can only be stained for a single stain.

Alternative approaches based on optical techniques have been proposed which use one or more stains to generate virtual histological images directly from the freshly excised tissue samples [1-3]. For instance, microscopic techniques such as single-photon confocal fluorescence microscopy and non-linear fluorescence techniques require staining with a dye such as acridine orange. These methods do not require the making of the tissue section and therefore bypass the time-consuming FFPE process. However, these microscopic techniques are limited by the smaller field of view (FOV) limited by the morphological tissue architecture information content and require use of dyes

Dye-free optical approaches based on stimulated Raman microscopy [4] and autofluorescence microscopy [5] have been proposed and demonstrated but these techniques are limited with the smaller FOV and suited for small tissue biopsy or sectioned tissue and not applicable for imaging whole tissue blocks.

What is needed is a histology system and method that decreases the amount of time required to produce useful histological results and one that does not require multiple tissue sections.

### BRIEF DESCRIPTION OF THE DRAWINGS

FIG. 1 is a schematic representation of a conventional pathology workflow for tissue samples.

FIG. 2 is a schematic representation of a present disclosure multi-spectral AF and reflectance based virtual histology approach embodiment.

FIG. 3 is a diagrammatic illustration of a present disclosure system embodiment.

FIG. 4 diagrammatically illustrates a non-limiting example of a method for training a present disclosure virtual staining network.

FIG. 5 diagrammatically illustrates a non-limiting example of a trained present disclosure virtual staining network.

FIG. 6 is a schematic representation of a present disclosure system that includes image focusing and registration.

FIG. 7 is a schematic representation of a present disclosure system that includes image focusing, registration, and image resolution enhancement.

FIG. 8 is a schematic representation of an application of the present disclosure.

FIG. 9 is a schematic representation of an application of the present disclosure.

FIG. 10 is a schematic representation of an application of the present disclosure.

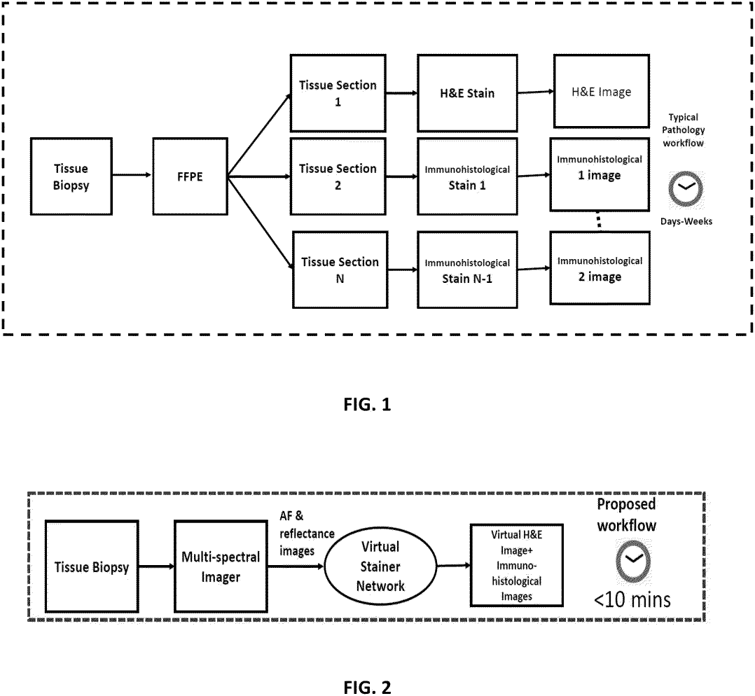

### SUMMARY

According to an aspect of the present disclosure, a method of producing a virtually stained histological tissue sample is provided that includes: a) acquiring a plurality of autofluorescence (AF) images of an unstained tissue sample, each AF image of the plurality of images produced by interrogating the tissue sample at an AF excitation wavelength configured to produce AF emissions at an AF emission wavelength, wherein the AF excitation wavelength and the AF emission wavelength used to produce each AF image of the plurality of AF images is different from the AF excitation wavelength and the AF emission wavelength used to produce the other AF images of the plurality of AF images; b) virtually staining the tissue sample using the plurality of AF images using artificial intelligence to represent a coloration of at least one histological stain; and c) producing a virtually stained histological tissue sample from the virtual staining.

In any of the aspects or embodiments described above and herein, the method may include acquiring at least one reflectance image of the tissue sample produced by interrogating the tissue sample at a reflectance excitation wavelength, and the virtually staining of the tissue sample may include using a reflectance image.

In any of the aspects or embodiments described above and herein, the AF excitation wavelengths may be different from the reflectance excitation wavelength.

In any of the aspects or embodiments described above and herein, the virtual staining may include virtually staining the unstained tissue sample using the plurality of AF images using artificial intelligence to represent the coloration of a first histological stain and virtually staining the unstained tissue sample using the plurality of AF images may use artificial intelligence to represent the coloration of a second histological stain.

In any of the aspects or embodiments described above and herein, the first histological stain may be hematoxylin and eosin.

In any of the aspects or embodiments described above and herein, the method may include producing a virtually stained immunohistological tissue sample from the virtual staining.

In any of the aspects or embodiments described above and herein, the method may include focusing each AF image of the plurality of AF images.

In any of the aspects or embodiments described above and herein, the method may include registering each AF image of the plurality of AF images with the others of the plurality of AF images.

In any of the aspects or embodiments described above and herein, each AF image of the plurality of AF images has a resolution, and the method may include increasing the resolution of each AF image of the plurality of AF images with one another.

According to another aspect of the present disclosure, a system for producing a virtually stained histological tissue sample is provided that includes an excitation light source, one or more light detectors, and a system controller. The system controller is in communication with the excitation light source, the one or more light detectors, and a non-transitory memory storing instructions. The instructions when executed cause the system controller to: a) control the excitation light source and the one or more light detectors to acquire a plurality of autofluorescence (AF) images of an unstained tissue sample, each AF image of the plurality of images produced by interrogating the tissue sample at an AF excitation wavelength produced by the excitation light source, the AF excitation wavelength configured to produce AF emissions at an AF emission wavelength, and wherein the AF excitation wavelength and the AF emission wavelength used to produce each AF image of the plurality of AF images is different from the AF excitation wavelength and the AF emission wavelength used to produce the other AF images of the plurality of AF images; b) virtually stain the tissue sample using the plurality of AF images using artificial intelligence to represent a coloration of at least one histological stain; and c) produce a virtually stained histological tissue sample from the virtual staining.

In any of the aspects or embodiments described above and herein, the instructions when executed may cause the system controller to control the excitation light source and the one or more light detectors to acquire at least one reflectance image of the unstained tissue sample by interrogating the tissue sample at a reflectance excitation wavelength, and wherein the virtually staining of the tissue sample includes using the at least one reflectance image.

In any of the aspects or embodiments described above and herein, the instructions when executed may cause the system controller to produce a virtually stained immunohistological tissue sample from the virtual staining.

In any of the aspects or embodiments described above and herein, the instructions when executed may cause the system controller to focus each AF image of the plurality of AF images.

In any of the aspects or embodiments described above and herein, the instructions when executed cause the system controller to register each AF image of the plurality of AF images with the others of the plurality AF images.

In any of the aspects or embodiments described above and herein, each AF image of the plurality of AF images has a resolution, and the instructions when executed may cause the system controller to increase the resolution of each AF image of the plurality of AF images with one another.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### DETAILED DISCLOSURE

The rapid availability of histological results is important in cancer care both in diagnosis, surgery, and pathological labs. As will be described below, the present disclosure provides a histology system and method that dramatically decreases the amount of time required to produce useful histological results and does not require multiple tissue sections, one that can be used to produce useful information for biopsy evaluation and for triaging the tissue sections in the surgical pathology lab. FIG. 2 illustrates the dramatic difference made possible in pathology workflow using the present disclosure.

The present disclosure leverages the fact that biomolecules present in different tissues provide discernible and repeatable autofluorescence [6-8] and reflectance [6] spectral patterns. The endogenous fluorescence signatures offer useful information that can be mapped to the functional, metabolic and morphological attributes of a biological sample, and can therefore be used for diagnostic purposes. Biomolecular changes occurring in the cell and tissue state during pathological processes and disease progression result in alterations of the amount and distribution of endogenous fluorophores and form the basis for classification. Tissue autofluorescence (AF) has been proposed to detect various malignancies including cancer by measuring either differential intensity [7] or lifetimes of the intrinsic fluorophores [8]. Biomolecules such as tryptophan, collagen, elastin, nicotinamide adenine dinucleotide (NADH), flavin adenine dinucleotide (FAD), porphyrins, etc. present in tissue provide discernible and repeatable autofluorescence spectral patterns. Label-free approaches based on vibrational spectroscopy such as stimulated Raman [9] and Infra-red (IR) microscopies [10] have also been proposed but they are slower, limited by smaller FOV, require sophisticated instrumentation, and are prohibitively expensive. Autofluorescence-based virtual histology which requires autofluorescence microscopic images is reported [11] but on fixed tissue sections.

The present disclosure also leverages the fact that different histological stains produce distinct colorations that are used for identification purposes. Embodiments of the present disclosure are operable to produce useful histological information by creating a plurality of “virtually stained” images of an unstained tissue section, which may include multiple virtually stained images based on a coloration that is associated with a particular histological stain, or which may include multiple virtually stained images each having a coloration that is associated with different respective histological stain. The stain coloration from a single histological stain may not, in some instances, provide enough information to differentiate all tissues, cellular structures, or chemical substances. The present disclosure makes it is possible to “virtually stain” a single tissue section to produce multiple images relating to a specific histological stain (e.g., H&E) coloration and also to produce multiple images of a single tissue section relating to multiple different histological stain colorations and thereby provide a robust means for producing the requisite information for a histological analysis.

The present disclosure system includes an excitation light source, one or more light detectors, and a system controller that is configured to perform the functionality described herein. The present disclosure system is not limited to any particular excitation light source and light detector configuration, and the system may include additional elements; e.g., light filtration elements, etc. PCT application number PCT/US2022/032526, commonly assigned with the present application and hereby incorporated by reference in its entirety, discloses an example of an acceptable light source, light detector, and system controller configuration that may be used to produce AF images and diffuse reflectance images of a tissue sample section.

The excitation light source may be configured to produce excitation light centered at a plurality of distinct wavelengths or may include a white light source coupled with filtering that enables distinct wavelengths to be produced. The excitation wavelengths are those that will produce useful AF emissions and/or useful reflectance signals from a tissue sample section; e.g., wavelengths based on the photometric properties associated with one or more biomolecules (or tissue type, etc.) of interest. Excitation light at wavelengths in the ultraviolet (UV) region (e.g., about 100-400 nm) and in the visible region (e.g., 400-700 nm) are non-limiting examples of excitation light that produce useful AF emissions and/or useful reflectance signals from a tissue sample section. Non-limiting examples of acceptable excitation light sources include lasers and light emitting diodes (LEDs) that may be centered at particular wavelengths, or a tunable excitation light source configured to selectively produce light centered at respective different wavelengths. The present disclosure is not limited to any particular type of excitation light unit.

The present disclosure system may utilize a variety of different light detector types to sense light and provide signals representative thereof. Non-limiting examples of an acceptable light detectors include those that convert light energy into an electrical signal such as photodiodes, avalanche photodiodes, a charge coupled device (“CCD”) array, an intensified charge coupled device (“ICCD”) array, a complementary metal-oxide-semiconductor (“CMOS”) image sensor, or the like. The light detector may take the form of a camera.

The system controller is in communication with other system components such as the light source and the light detector and may be in communication with other system components. The system controller may be in communication with system components to control the operation of the respective component and/or to receive signals from and/or transmit signals to that component to perform the functions described herein. The system controller may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system to accomplish the same algorithmically and/or coordination of system components. The system controller includes or is in communication with one or more memory devices. The present disclosure is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. The system controller may include, or may be in communication with, an input device that enables a user to enter data and/or instructions, and may include, or be in communication with, an output device configured, for example to display information (e.g., a visual display or a printer), or to transfer data, etc. Communications between the system controller and other system components may be via a hardwire connection or via a wireless connection.

Some embodiments of the present disclosure may include optical filtering elements configured to filter excitation light, or optical filtering elements configured to filter emitted light (including reflected light), or both.

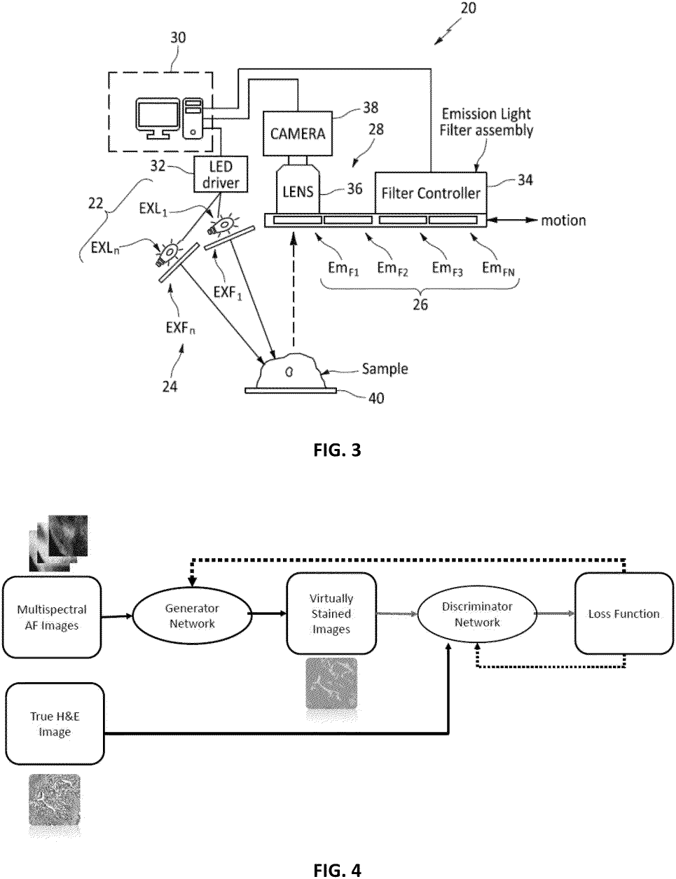

An exemplary embodiment of a present disclosure system 20 is diagrammatically illustrated in FIG. 3. This system 20 embodiment includes an excitation light source 22, an excitation light filter arrangement 24, an emission/reflectance light filter assembly 26, a photodetector arrangement 28, and a system controller 30. The excitation light source 22 includes a plurality of independent excitation light sources (e.g., EXL₁... EXL), each operable to produce an excitation light centered at a particular wavelength and each centered on an excitation wavelength different from the others. The independent excitation light sources are directly or indirectly in communication with the system controller 30. The LEDs may be in communication with an LED driver 32 that may be independent of the system controller 30 or the functionality of the LED driver 32 may be incorporated into the system controller 30. The excitation light filter arrangement 24 shown in FIG. 3 includes an independent bandpass filter (EXF₁... EXFₙ) for each excitation light source 22 and the bandwidth filter properties for each independent bandpass filter are tailored for the respective excitation light source 22 with which it is associated. The system 20 embodiment diagrammatically shown in FIG. 3 includes an emission light filter assembly 26 having a filter controller 34 and a linear array of bandpass filters (e.g., Em_{F1}, Em_{F2} ... Em_{FN}). The filter controller 34 is configured to selectively position each respective bandpass filter in a light path between the tissue sample section (i.e., the source of the emitted /reflected light) and the photodetector arrangement 28 to permit filtering of the emitted/reflected light prior to detection by the photodetector arrangement 28. The filter controller 34 may be in communication with the system controller 30, or the filter controller 34 functionality may be incorporated into the system controller 30. As stated above, the bandwidth of the respective bandpass filters for the emitted / reflected light are typically chosen based on the photometric properties associated with one or more biomolecules of interest; e.g., to allow only emitted / reflected light from a limited portion of the biomolecule emission/reflectance response that is of interest to facilitate the analyses described herein. The photodetector arrangement 28 may include a lens arrangement 36 and a camera 38. In some embodiments, the lens arrangement 36 may be controllable to selectively change lens configurations and is in communication with the system controller 30. The camera 38 is configured to produce signals representative of the sensed emitted / reflected light passed through the emission light filter assembly 26. The aforesaid signals may be referred to as an “image” or may be processed into an image. The camera 38 is in communication with the system controller 30. As stated above, system shown in FIG. 3 and described above is a non-limiting example of a present disclosure system configuration. An excised tissue sample section may be placed on a stage 40 or other platform at a position optically aligned with the photodetector arrangement 28.

As indicated above, processes for producing AF images of a tissue sample section and processes for producing diffuse reflectance images of a tissue sample section are known, and the present disclosure is not limited to any particular processes. PCT application number PCT/US2022/032526, commonly assigned with the present application and hereby incorporated by reference in its entirety, discloses acceptable processes that may be used to produce AF images and diffuse reflectance images of a tissue sample section.

The present disclosure uses artificial intelligence (AI) techniques, including machine learning, (collectively “AI techniques”) to produce the virtually stained histological images that are representative of known histological stains. A trained present disclosure system is operable to produce a virtually stained histological image (or virtual immunohistological image) from a plurality of AF images (or a mosaic of AF images), each image acquired at different excitation and emission wavelength, and in some instances also using one or more reflectance images. Embodiments of the present disclosure may be configured to produce a virtually stained histological image representative of a particular type of histological stain (e.g., H&E), and other embodiments may be configured to produce more than one type of virtually stained histological image; e.g., a first virtually stained histological image representative of H&E stain, a second virtually stained histological image representative of Van Gieson stain, a third virtually stained histological image representative of Toluidine Blue stain, a fourth virtually stained histological image representative of Alcian Blue, and so on.

The AI aspect of the present disclosure may be trained in a variety of different ways. FIG. 4 diagrammatically illustrates a non-limiting example of a method for training a present disclosure virtual staining network to produce a virtually stained image of a particular tissue sample section from a plurality of AF images and in some instances also one or more reflectance images. The AI may include a generative adversarial network (“GAN”) that uses deep learning methods, such as convolutional neural networks, for training purposes. The present disclosure is not limited to any particular AI technique.

The training process begins with producing a plurality of AF images (and possibly one or more reflectance images) of a tissue sample section. The method then includes generating a virtually stained image of the tissue sample section based on the AF images (and reflectance image when used) of the tissue sample. The virtually stained image is based on a selected histological stain (e.g., H&E) so that the virtually stained image is representative of the coloration that would have been produced if that tissue sample section had actually been stained by the chosen histological stain (e.g., H&E). The process of generating the virtually stained images may be described as being performed in a “generator network”.

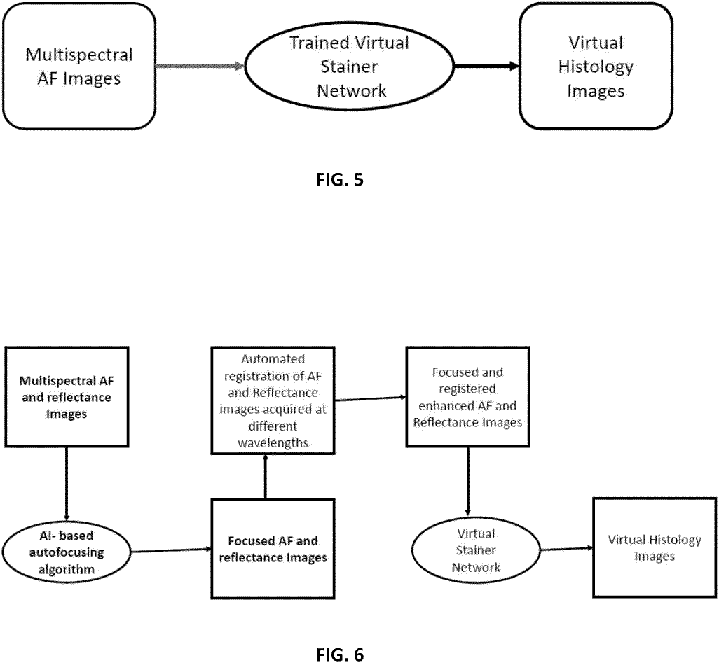

The virtually stained image is subsequently evaluated relative to a corresponding actual image (e.g., a bright light image) of the tissue sample section stained with the selected histological stain (e.g., H&E) to identify differences between them. The process of identifying the discrepancies between the actual histological image and the generated virtual histological image may be described as being performed in a “discriminator network”. The discrepancies between the actual histological image and the generated virtual histological image may then be formulated as a loss function. The loss function may be communicated to the discriminator network and to the generator network for use in backpropagation. The generator network, in turn, may utilize the loss function to generate a corrected virtual image which is then communicated to the discriminator network. This process may be performed iteratively until the discriminator network cannot distinguish between the generated virtually stained image and the actual image; i.e., at this point the generator network “wins”. The AI process is then trained to associate certain colorations with certain AF image elements (and possibly certain reflectance image elements). This process is repeated on a number of tissue sample sections for each histological stain sufficient to produce a desired degree of accuracy. In this manner, the generator network learns the statistical transformation between the plurality of multispectral AF images and the reflectance images with corresponding bright-field histological images of the same tissue block. The input from the loss function enables the discriminator network to learn how to distinguish between a true bright field histological stained image of a tissue sample section and the generator network’s output virtual histological image. After trainings, the generator network artificially manufactures virtual histological images and the discriminator network assesses the similar of each to an actual histological image. By way of backpropagation, the discriminator network’s classification helps the generator network to update its weights and thereby fine-tune the virtual histological images being produced. Ultimately, after several iterations, the generator network begins to output higher-quality virtually stained histological images and the discriminator network becomes better at distinguishing the virtually stained histological images from the actual histological images. Once the network is trained, it can produce virtually stained images representative of histological stains including H&E or other histological stains as well as immunohistological stains from a panel of input AF and reflectance images. FIG. 5 diagrammatically illustrates a trained present disclosure system.

FIG. 6 is a flow diagram illustrating an embodiment of the present disclosure methodology. FIG. 6 indicates that a plurality of multispectral AF images and reflectance images are produced. In some instances, the plurality of images may include a plurality of only multispectral AF images. Non-limiting examples of how the AF images and/or diffuse reflectance images may be produced are described above. The AF images and reflectance images may then be processed for focusing purposes. For example, an AI-based autofocusing algorithm may be used. The present disclosure is not limited to any particular focusing methodology. The focused AF and reflectance images may then be processed to create registration between the AF and reflectance images. The registration process is intended to correct (e.g., within an acceptable threshold) any misalignment between the images. The present disclosure is not limited to any particular image registration process. The now focused and registered images are subsequently processed using the present disclosure virtual staining process to produce virtually stained histological images representative of a tissue sample section that has been stained with a histological stain (e.g., H&E), or a virtual immunohistological images, or the like.

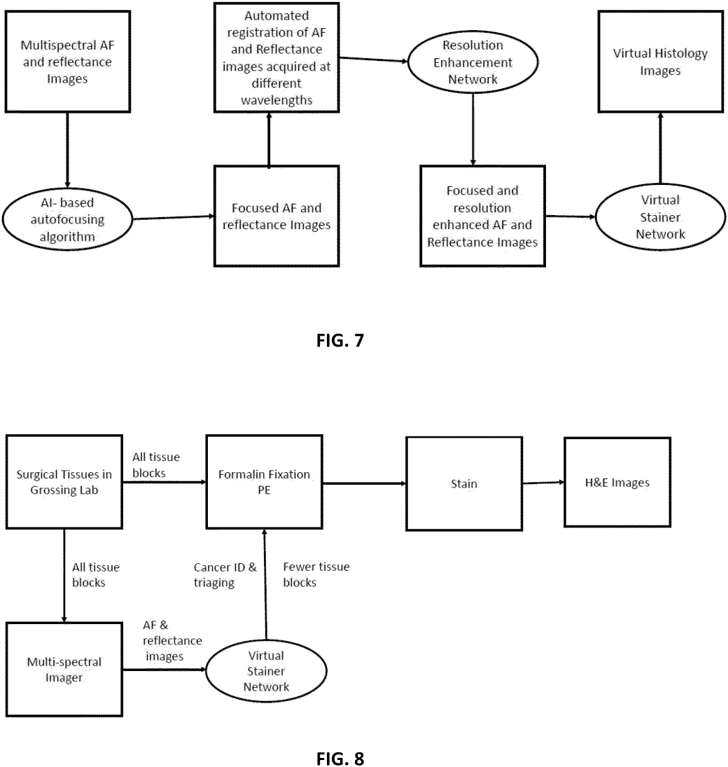

FIG. 7 is a flow diagram illustrating an embodiment of the present disclosure methodology. The present disclosure methodology embodiment shown in FIG. 7 is similar to that depicted in FIG. 6 and described above. The embodiment shown in FIG. 7 includes a process for enhancing the resolution of the focused and registered images prior to those images being processed using the present disclosure virtual staining process. In some embodiments, the resolution enhancing process may utilize a deep learning algorithm to improve the resolution of the AF and reflectance images and autofocusing of the acquired images [12]. After adequate training of an algorithm with low and high-resolution images acquired from the same tissue regions, high-resolution images can be generated from low-resolution images thereby increasing the speed and processing efficiency of the process. The present disclosure is not limited to any particular process for improving image resolution.

The disclosed virtual histology method is different from the previously reported virtual autofluorescence in numerous ways. For example, the present disclosure embodiments may use a multi-modal approach that may utilize a panel of AF and reflectance images, unlike a single AF image. As another example, embodiments of the present disclosure may not require making of any slide and may be performed on non-fixed, unsectioned tissue samples. As yet another example, embodiments of the present disclosure may be described as using rapid “snapshot” imaging that is very useful and practical in clinical settings. In addition to the applicability in biopsy diagnosis and triaging tissue samples, this approach will also be applicable in frozen section analysis.

FIGS. 8-10 illustrate applications of the present disclosure that illustrate the significant utility of embodiments of the present disclosure. In FIG. 8, tissue samples within a grossing laboratory may be used to produce multispectral AF images and reflectance images (when included) which are then transformed into virtually stained histological images (e.g., within a “virtual stainer network”) as described herein. After the multispectral imaging process, at least some of those same tissue sample sections may be prepared in a conventional manner for read by a pathologist; e.g., the tissue samples may be prepared as formalin-fixed, paraffin-embedded (FFPE) tissue sample sections that are subsequently stained with histological stains; e.g., H&E. As indicated above, however, this process performed on a clinically sufficient number of samples is slow and is costly. Using the present disclosure system, the virtually stained histological images are prepared in a matter of minutes. The virtually stained histological images may then be reviewed by the pathologist prior to performing the conventional preparation steps. The virtually stained histological images may enable the pathologist to elect to conventionally prepare fewer tissue sample sections (i.e., only those tissue sample sections that appear to have the desired information), thereby potentially decreasing the workload of the pathologist, decreasing the amount of time to produce the desired information, and possibly providing information that improves the ability of the pathologist to provide the desired information.

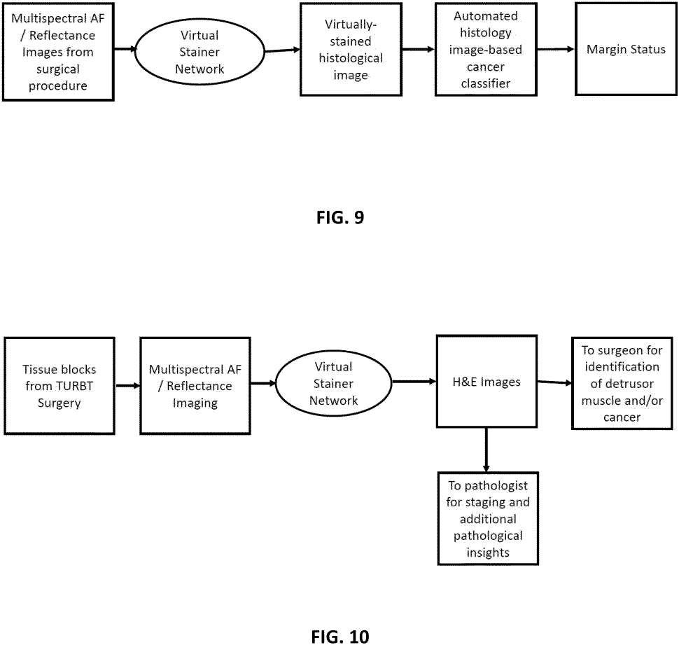

In FIG. 9, multispectral AF images and reflectance images (when included) are produced and then transformed into virtually stained histological images (e.g., within a “virtual stainer network”) as described herein. The virtually stained histological images may then be processed within an automated histology image-based cancer classifier to assist a surgeon in determining margin status of a tumor resection; e.g., a breast cancer tumor resection. In this manner, critical margin status information may be provided to a surgeon in a very short period of time (e.g., minutes). Currently, the success of many tumor resections depends on the experience and judgement of the surgeon to decide how much tissue to remove around the tumor; i.e., the margin. As a result, surgeons often perform what is called cavity shaving, which can result in the removal of excessive amounts of healthy tissue. Conversely, for many patients, post-operative surgical pathology results show that the entire tumor was not removed during the initial surgery, necessitating a follow up surgery to remove residual cancer tissue. This can be traumatic to the cancer patient, adding stress and resulting in long-term detrimental effects on the patient outcome. This application of the present disclosure can provide useful information in an effective amount of time useful to the surgeon in tumor resection.

In FIG. 10, tissue samples acquired from a transurethral resection of a bladder (TURBT) may be imaged to produce multispectral AF images and reflectance images (when included). Using the present disclosure, those AF images and reflectance images may then be transformed into virtually stained histological images (e.g., virtual H&E images produced within a “virtual stainer network”) as described herein. The virtually stained histological images may then be provided (in some instances with the unstained tissue sample sections) to a pathologist for evaluation in a manner like than described above. The same virtually stained histological images may also be provided to the surgeon performing the TURBT to assist the surgeon in identifying detrusor muscle and cancerous tissue within the tissue sample sections. The presence of detrusor muscle is surrogate for the resection quality in TURBT. Hence, FIG. 10 illustrates another application wherein the present disclosure can provide useful information in an effective amount of time.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

The singular forms “a,” “an,” and “the” refer to one or more than one, unless the context clearly dictates otherwise. For example, the term “comprising a sample” includes single or plural samples and is considered equivalent to the phrase “comprising at least one sample.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on-may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

### References

1. L. C. Cahill et al., Rapid virtual hematoxylin and eosin histology of breast tissue specimens using a compact fluorescence nonlinear microscope. Lab Invest 98, 150-160 (2018).
2. C. Elfgen et al., Comparative analysis of confocal microscopy on fresh breast core needle biopsies and conventional histology. Diagnostic Pathology 14, 58 (2019).
3. P. Pradhan et al., Computational tissue staining of non-linear multimodal imaging using supervised and unsupervised deep learning. Biomed. Opt. Express 12, 2280-2298 (2021).
4. D.A. Orringer et al., Rapid intraoperative histology of unprocessed surgical specimens via fibre-laser-based stimulated Raman scattering microscopy, Nat Biomed Eng 1, 0027 (2017).
5. U.S. Pat. Pub. No. 2021/0043331, Method and System for Digital Staining of label-Free Fluorescence Images Using Deep Learning
6. T. M. Bydlon, R. Nachabe, N. Ramanujam, H. J. Sterenborg, B. H. Hendriks, Chromophore based analyses of steady-state diffuse reflectance spectroscopy: current status and perspectives for clinical adoption. J Biophotonics 8, 9-24 (2015).
7. M. Wang et al., Autofluorescence Imaging and Spectroscopy of Human Lung Cancer. Applied Sciences 7, 32 (2017).
8. M. Marsden et al., Intraoperative Margin Assessment in Oral and Oropharyngeal Cancer Using Label-Free Fluorescence Lifetime Imaging and Machine Learning. IEEE Transactions on Biomedical Engineering 68, 857-868 (2021).
9. B. Sarri et al., Stimulated Raman histology: one to one comparison with standard hematoxylin and eosin staining. Biomed. Opt. Express 10, 5378-5384 (2019).
10. M. Schnell et al., All-digital histopathology by infrared-optical hybrid microscopy. Proc Natl Acad Sci USA 117, 3388-3396 (2020).
11. Y. Rivenson et al., Virtual histological staining of unlabelled tissue-autofluorescence images via deep learning. Nature Biomedical Engineering 3, 466-477 (2019).
12. C. Jiang et al., Blind deblurring for microscopic pathology images using deep learning networks. arXivpreprint arXiv:2011.11879 (2020).

1. A method of producing a virtually stained histological tissue sample, comprising:
acquiring a plurality of autofluorescence (AF) images of an unstained tissue sample, each AF image of the plurality of images produced by interrogating the tissue sample at an AF excitation wavelength configured to produce AF emissions at an AF emission wavelength, wherein the AF excitation wavelength and the AF emission wavelength used to produce each AF image of the plurality of AF images is different from the AF excitation wavelength and the AF emission wavelength used to produce the other AF images of the plurality of AF images;
virtually staining the tissue sample using the plurality of AF images using artificial intelligence to represent a coloration of at least one histological stain;
producing a virtually stained histological tissue sample from the virtual staining.

2. The method of claim 1, further including acquiring at least one reflectance image of the tissue sample produced by interrogating the tissue sample at a reflectance excitation wavelength; and
wherein said virtually staining the tissue sample includes using the at least one reflectance image.

3. The method of claim 2, wherein the AF excitation wavelengths are different from the reflectance excitation wavelength.

4. The method of claim 1, wherein the virtual staining includes virtually staining the unstained tissue sample using the plurality of AF images using artificial intelligence to represent the coloration of a first histological stain and virtually staining the unstained tissue sample using the plurality of AF images using artificial intelligence to represent the coloration of a second histological stain.

5. The method of claim 4, wherein the first histological stain is hematoxylin and eosin.

6. The method of claim 1, further comprising producing a virtually stained immunohistological tissue sample from the virtual staining.

7. The method of claim 1, further comprising focusing each said AF image of the plurality of AF images.

8. The method of claim 7, further comprising registering each said AF image of the plurality of AF images with the others of the plurality of AF images.

9. The method of claim 7, wherein each said AF image of the plurality of AF images has a resolution, and further comprising increasing the resolution of each said AF image of the plurality of AF images with one another.

10. A system for producing a virtually stained histological tissue sample, comprising:
an excitation light source;
one or more light detectors; and
a system controller in communication with the excitation light source, the one or more light detectors, and a non-transitory memory storing instructions, which instructions when executed cause the system controller to:
control the excitation light source and the one or more light detectors to acquire a plurality of autofluorescence (AF) images of an unstained tissue sample, each AF image of the plurality of images produced by interrogating the tissue sample at an AF excitation wavelength produced by the excitation light source, the AF excitation wavelength configured to produce AF emissions at an AF emission wavelength, and wherein the AF excitation wavelength and the AF emission wavelength used to produce each AF image of the plurality of AF images is different from the AF excitation wavelength and the AF emission wavelength used to produce the other AF images of the plurality of AF images;
virtually stain the tissue sample using the plurality of AF images using artificial intelligence to represent a coloration of at least one histological stain; and
produce a virtually stained histological tissue sample from the virtual staining.

11. The system of claim 10, wherein the instructions when executed cause the system controller to control the excitation light source and the one or more light detectors to acquire at least one reflectance image of the unstained tissue sample by interrogating the tissue sample at a reflectance excitation wavelength, and wherein the virtually staining of the tissue sample includes using the at least one reflectance image.

12. The system of claim 11, wherein the AF excitation wavelengths are different from the reflectance excitation wavelength.

13. The system of claim 10, wherein the virtual staining includes virtually staining the unstained tissue sample using the plurality of AF images using artificial intelligence to represent the coloration of a first histological stain and virtually staining the unstained tissue sample using the plurality of AF images using artificial intelligence to represent the coloration of a second histological stain.

14. The system of claim 13, wherein the first histological stain is hematoxylin and eosin.

15. The system of claim 10, wherein the instructions when executed cause the system controller to produce a virtually stained immunohistological tissue sample from the virtual staining.

16. The system of claim 10, wherein the instructions when executed cause the system controller to focus each said AF image of the plurality of AF images.

17. The system of claim 16, wherein the instructions when executed cause the system controller to register each said AF image of the plurality of AF images with the others of the plurality AF images.

18. The system of claim 16, wherein each said AF image of the plurality of AF images has a resolution, and wherein the instructions when executed cause the system controller to increase the resolution of each said AF image of the plurality of AF images with one another.
